(19) United States
(12) Patent Application Publication
(10) Pub. No.: US 2021/0031443 A1
(43) Pub. Date: Feb. 4, 2021

(54) ADDITIVE MANUFACTURING OF CONNECTORS AND FASTENERS

(71) Applicant: The Boeing Company, Chicago, IL (US)

(72) Inventors: Nicholas James Amanatides, Philadelphia, PA (US); Brandon H. Wegge, Brentwood, MO (US)

(21) Appl. No.: 16/529,612

(22) Filed: Aug. 1, 2019

(51) Int. Cl. B29C 64/153; B22F 3/105

(52) U.S. Cl. CPC B29C 64/153; B33Y 10/00; B22F 3/1055

(57) ABSTRACT

An additive manufacturing process is disclosed. A parent member is additively manufactured. The parent member includes a first end and a retention portion proximate to the first end. A support member is additively manufactured onto the parent member. A connector is additively manufactured onto the support member such that the support member is connected between the parent member and the connector. The support member is fracturable to allow movement of the connector with respect to the parent member. The retention portion is configured to prevent the connector from being removed from the first end upon fracturing of the at least one support member. The connector is operable to engage an external member to hold the parent member in a position with respect to the external member.

### FIELD

The present disclosure relates generally to the field of additive manufacturing, and more specifically to additively manufacturing connectors and/or fasteners.

### BACKGROUND

Additive manufacturing refers to processes of joining material(s) to make members and/or assemblies from 3D model data, usually layer upon layer. In recent years, additive technologies have been adopted in a variety of manufacturing sectors, including aerospace, automotive, medical, and consumer products. Additive manufacturing of various members and/or assemblies may provide numerous benefits for an industry sector. As one example, additive manufacturing may allow for a plurality of different members separately manufactured according to a different manufacturing process to be consolidated into a single additive manufacturing process. As another example, additive manufacturing may allow for members to be manufactured on-demand, which may alleviate the need for large inventories of mass-produced members. As yet another example, additive manufacturing may allow for a member to be redesigned subsequent to the initial design process without having to retool manufacturing equipment to accommodate the redesign.

### SUMMARY

To address the above issues, according to one aspect of the present disclosure, an additive manufacturing method is disclosed. A parent member is additively manufactured. The parent member includes a first end and a retention portion proximate to the first end. A support member is additively manufactured onto the parent member. A connector is additively manufactured onto the support member such that the support member is connected between the parent member and the connector. The support member is fracturable to allow movement of the connector with respect to the parent member. The retention portion is configured to prevent the connector from being removed from the first end upon fracturing of the at least one support member. The connector is operable to engage an external member to hold the parent member in a position with respect to the external member.

The features, functions, and advantages that have been discussed can be achieved independently in various embodiments or may be combined in yet other embodiments further details of which can be seen with reference to the following description and drawings.

### BRIEF DESCRIPTION OF THE DRAWINGS

FIG. 1 is a flowchart of an exemplary embodiment of an additive manufacturing method.

FIGS. 2A and 2B are diagrammatic representations of an exemplary embodiment of an additively manufactured assembly.

FIG. 3A is a diagrammatic representation of an additively manufactured connector connected to an additively manufactured parent member.

FIG. 3B is a diagrammatic representation of an additively manufactured connector fractured so as to be movable with respect to an additively manufactured parent member.

FIG. 4A is a diagrammatic representation of an additively manufactured engagement sleeve connected to an additively manufactured parent member.

FIG. 4B is a diagrammatic representation of an additively manufactured engagement sleeve fractured so as to be movable with respect to an additively manufactured parent member.

FIGS. 5A-5D are diagrammatic representations illustrating a process of an additively manufactured assembly being connected to an external member.

FIG. 6 is a diagrammatic representation illustrating an exemplary embodiment of a retention portion of an additively manufactured parent member.

FIG. 7 is a diagrammatic representation of an exemplary embodiment of an additively manufactured assembly including a parent member and a connector captively retained on the parent member.

FIGS. 8 and 9 are diagrammatic representations of an exemplary embodiment of an additively manufactured assembly including an additively manufactured parent member and an additively manufactured fastener retained on the parent member.

FIGS. 10A-10B are diagrammatic representations illustrating a process of an additively manufactured assembly being connected to an external member.

### DETAILED DESCRIPTION

Improved methods for additive manufacturing of an assembly comprising a parent member and a connector or fastener that is prevented from being removed from a first end of the parent member are provided. The improved additive manufacturing methods allow for the parent member and the connector or fastener to be additively manufactured together in the same additive manufacturing process. Additionally, the improved additive manufacturing methods allow for the connector or fastener to be retained on the parent member without the need for additional steps to modify the parent member after the parent member has been formed. According to such improved additive manufacturing methods, the number of steps to produce the additively manufactured assembly may be reduced. Also, the resulting additively manufactured assembly may be more robust, since the parent member does not need to be modified subsequent to being formed. Moreover, since the parent member does not need to be modified subsequent to being formed, the parent member is less likely to become degraded during the manufacturing process, which may increase the overall manufacturing yield of the additively manufactured assembly.

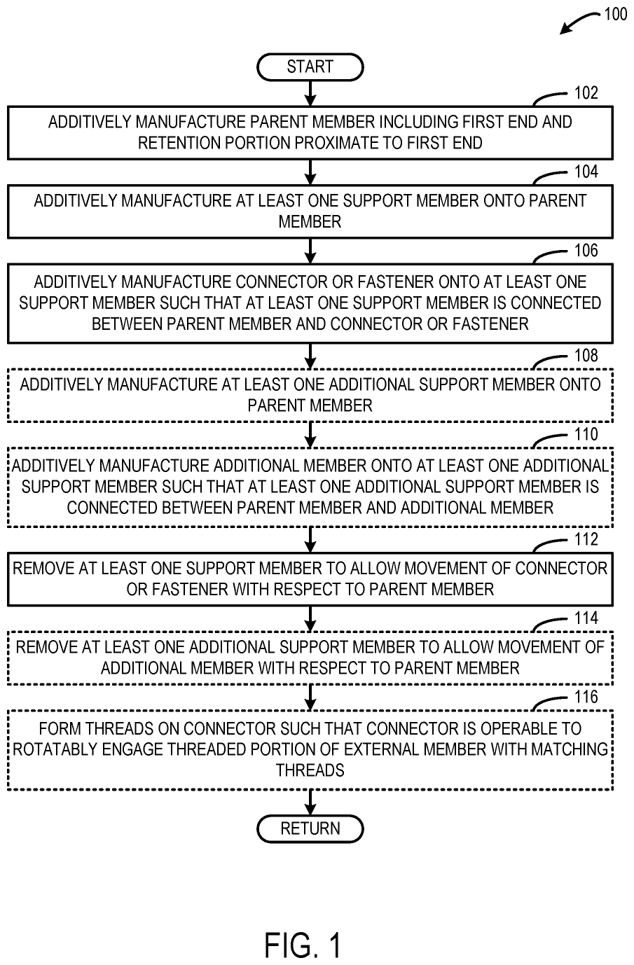

FIG. 1 is a flowchart of an exemplary embodiment of an additive manufacturing method 100. The method 100 may be performed using any suitable additive manufacturing equipment including hardware and software components.

At 102, the method 100 includes additively manufacturing a parent member including a first end and a retention portion proximate to the first end. In the scope of this disclosure, the parent member is generally referred to as having a tube shape, though it will be appreciated that the parent member may have any suitable geometry. At 104, the method 100 includes additively manufacturing at least one support member onto the parent member. At 106, the method 100 includes additively manufacturing a connector or fastener onto the at least one support member such that the at least one support member is connected between the parent member and the connector or fastener. The support member(s) are configured to be fracturable (or otherwise removable) to allow movement of the connector or fastener with respect to the parent member. The support member(s) may act as spacer(s) between the parent member and the connector or fastener to allow for at least a portion of the connector or fastener to be spaced apart from the parent member. Furthermore, the retention portion is configured to prevent the connector from being removed from the first end upon fracturing of the support member(s). In some embodiments, the parent member may include two or more retention portions that prevent the connector or fastener from being removed from the parent member. In such embodiments, the connector or fastener may be captively retained on the parent member upon fracturing the support member(s).

As used herein, the term “connector” is defined as a hardware device that mechanically joins or affixes two or more members together. A connector may be configured to engage with a matching hardware device to form a pair of connectors. In other words, the connector may be operable to engage an external member to hold the parent member in a position with respect to the external member. In some examples, the connector may be configured as a “male” connector that is inserted into a “female” receptacle that holds the “male” connector. In other examples, the connector may be a “female” connector that is a receptacle that receives and holds a “male” connector. Non-limiting examples of connectors include nuts, fittings, couplers, clasps, clamps, latches and adapters, though it will be appreciated that a connector may take any suitable form.

As used herein, the term “fastener” is defined as a hardware device that is inserted into two or more members to mechanically join or affix the two or more members together. Non-limiting examples of fasteners include screws, bolts, and pins, though it will be appreciated that a fastener may take any suitable form.

The above-described additive manufacturing method steps or processes may be used to create a three-dimensional (3D) member or assembly where layers of material are formed, typically under computer control. An additively manufactured assembly can be of almost any shape or geometry and is produced using digital model data from a 3D model or another electronic data source. For example, an additively manufactured assembly may be formed based on a computer-aided design (CAD) model or an additive manufacturing file (AMF), or stereolithography (STL) file format by successively adding material layer-by-layer to accurately produce a member or assembly having a desired and/or predetermined dimension and/or geometry.

Any suitable type of additive manufacturing process or technology may be used to perform the additive manufacturing method steps described herein. Non-limiting examples of such additive manufacturing processes include 3D printing; direct energy deposition; direct metal laser sintering; direct metal printing; electron beam additive manufacturing; electron beam melting; electron beam powder bed manufacturing; fused deposition modeling; indirect powder bed manufacturing; laser cladding; laser deposition manufacturing; laser deposition welding; laser deposition welding/integrated milling; laser engineering net shaping; laser freeform manufacturing; laser metal deposition with powder; laser metal deposition with wire; laser powder bed manufacturing; laser puddle deposition; laser repair manufacturing; powder directed energy deposition; stereolithography; selective laser melting; selective laser sintering; small puddle deposition; or combinations thereof.

Laser sintering techniques may include selective laser sintering with both metals and polymers, and direct metal laser sintering. Selective laser melting does not use sintering for the fusion of powder granules but will completely melt the powder using a high-energy laser to create fully dense materials in a layer-wise deposition method that has mechanical properties similar to those of conventional manufactured metals. Electron beam melting (EBM) is a similar type of additive manufacturing technology for metal parts (e.g. titanium, titanium alloys). EBM manufactures parts by melting metal powder layer by layer with an electron beam in a high vacuum. Another method consists of an inkjet 3D printing system that creates the member one layer at a time by spreading a layer of powder (plaster or resins) and printing a binder in the cross-section of the member using an inkjet-like process. With laminated object manufacturing, thin layers are cut to shape and joined together.

Continuing with the method 100, in some embodiments a plurality of connectors, fasteners, or other members may be retained on the parent member. In some such embodiments, at 108, the method 100 optionally may include additively manufacturing at least one additional support member onto the parent member. At 110, the method 100 optionally may include additively manufacturing an additional member onto the at least one additional support member, such that the at least one additional support member is connected between the parent member and the additional member. In some embodiments, the additional member may include an engagement sleeve that is operable to interface with the retention portion, the connector, and the external member to form a seal between the parent member and the external member. In other embodiments, the additional member may include a second connector that is configured to engage a second external member to hold the parent member in a position with respect to the second external member. The at least one additional support member may be fracturable to allow movement of the additional member with respect to the parent member. The retention portion of the parent member may be configured to prevent the additional member from being removed from the first end upon fracturing of the at least one additional support member. In some embodiments, the additional member may be captively retained on the parent member upon fracturing the one or more additional support members, such that the additional member cannot be removed from the parent member.

At 112, the method 100 includes removing the at least one support member to allow movement of the connector or fastener with respect to the parent member. The at least one support member may be removed in any suitable manner. As one example, the support member(s) may be machined to allow separation of the connector or fastener from the parent member. In some examples, the support member(s) may be fractured and then subsequently removed. In other examples, the support member(s) may be fractured and removed in the same step or process. Upon fracturing and/or removal the support member(s), the connector or fastener may be configured to move with respect to the parent member in any suitable manner. In one example, a connector may be configured to move laterally with respect to a parent member (e.g., a tube). In another example, a fastener may be configured to move orthogonally with respect to a parent member.

In embodiments where at least one additional member is additively manufactured onto the parent member, at 114, the method 100 optionally may include removing the at least one additional support member to allow for movement of the additional member with respect to the parent member. As discussed above, the additional member may be an engagement sleeve or an additional connector or fastener, for example.

In some embodiments, the external member may include a threaded portion. In some such embodiments, at 116, the method 100 optionally may include forming threads on the connector that match the threaded portion of the external member such that the connector is operable to rotatably engage the threaded portion with the matching threads to hold the parent member in a position relative to the external member. As one example, forming the threads on the connector may include positioning the connector against the retention portion such that a portion of the connector extends beyond the retention portion, and machining threads into an interior sidewall of the connector. In another example, the threads may be formed in an exterior sidewall of the connector. Such external threads may be formed during additive manufacturing of the connector, via subsequent machining, or using some other manufacturing approach.

The above-described method may be performed to provide an additively manufactured assembly including a parent member and a connector or fastener that may be retained on the parent member without requiring additional modification of the parent member subsequent to the initial additive manufacturing process. Accordingly, the number of steps or processes required to additively manufacture the assembly may be reduced. Moreover, the assembly may be more robust based on not having to modify the parent member.

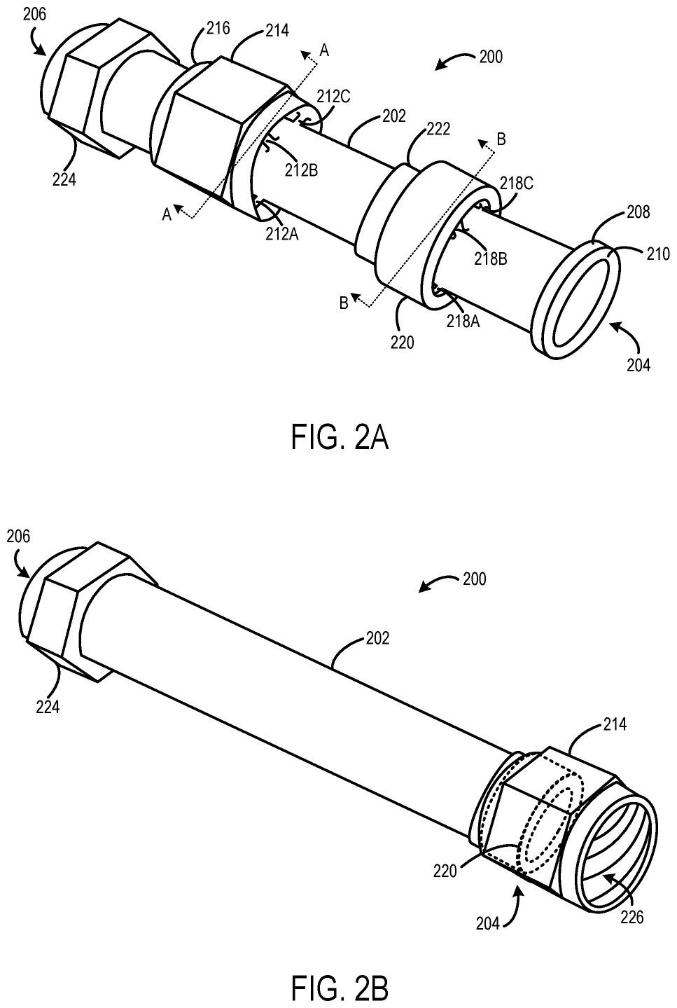

FIGS. 2A and 2B are diagrammatic representations of an exemplary embodiment of an additively manufactured assembly 200. For example, the additively manufactured assembly 200 may be additively manufactured according to the additive manufacturing method 100 shown in FIG. 1. The additively manufactured assembly 200 includes an additively manufactured parent member illustrated in this embodiment as a tube 202. The tube 202 includes a first end 204 and a second end 206 that opposes the first end 204. The tube 202 includes a hollow interior cavity to allow for fluid to flow through the tube 202. In one example, the tube may be configured to allow for the transport of air. In another example, the tube may be configured to allow for the transport of liquid such as water or fuel. The tube 202 may be formed from a material that is compatible with the particular fluid that is transported through the tube 202. In some examples, the tube 202 may be additively manufactured from metal. In other examples, the tube 202 may be additively manufactured from plastic. In yet other examples, the tube 202 may be additively manufactured from another suitable material.

A first retention portion 208 is formed proximate to the first end 204 of the tube 202. The first retention portion 208 surrounds an exterior perimeter of the tube 202 to form a collar. The first retention portion 208 has a diameter that is greater than an exterior diameter of the tube 202. In the illustrated embodiment, the first retention portion 208 has sidewalls 210 that are orthogonal to the exterior wall of the tube 202. The first retention portion 208 is flush with the first end 204 of the tube 202. In other embodiments, the retention portion 208 may be recessed from the first end 204. For example, the retention portion 208 may be recessed from the first end 204 to allow for the first end 204 to be inserted into an external member in order to aid in holding the parent member in a position with respect to the external member.

A plurality of additively manufactured support members 212 (e.g., 212A, 212B, 212C, 212D) are disposed on the tube 202. An additively manufactured connector 214 is disposed on the plurality of support members 212 such that the plurality of support members 212 are connected between the tube 202 and the connector 214. The plurality of support members 212 may act as spacers that allow for non-connected portions of the connector 214 to be spaced apart from the tube 202. It will be appreciated that the connector 214 may be supported by any suitable number of support members. For example, in other embodiments, the connector 214 may be supported by more or less than four support members.

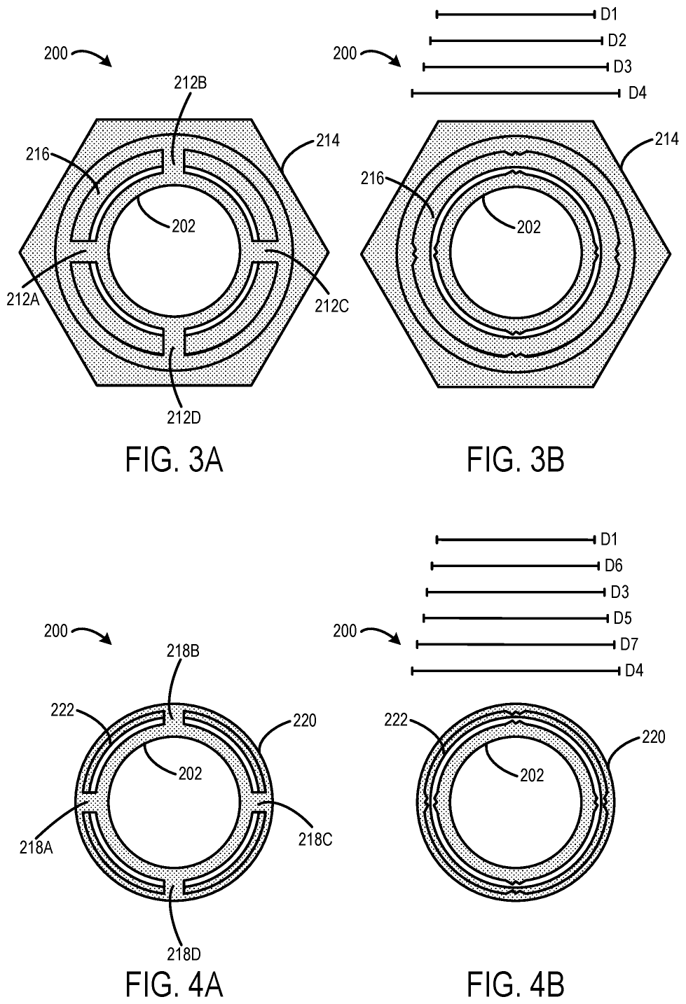

The plurality of support members 212 may be fracturable to allow movement of the connector 214 with respect to the tube 202. FIGS. 3A and 3B are diagrammatic representations of a cross section of the additively manufactured assembly 200 along line A-A shown in FIG. 2A. In FIG. 3A, the plurality of support members 212 are intact. In FIG. 3B, the plurality of support members 212 are fractured to allow for the connector 214 to move with respect to the tube 202. The connector 214 forms a cylindrical interior cavity having an interior diameter (D4) that is greater than an exterior diameter (D1) of the tube 202. The interior diameter (D4) of the cylindrical interior cavity is also greater than a diameter (D3) of the retention portion 208. The connector 214 includes a collar portion 216 having an interior diameter (D2) that is greater than a diameter (D1) of the tube 202 and that is less than a diameter (D3) of the retention portion 208. An exterior perimeter of the connector 214 is hexagonal in shape to accommodate a wrench or other tool for gripping and rotating the connector 214 to tighten the connector 214 onto an external member.

Upon fracturing the plurality support members 212, the connector 214 may slide laterally along the tube 202, as shown in FIG. 2B. The arrangement of the interior diameter (D4) of the connector 214 being greater than the diameter (D3) of the retention portion 208, and the interior diameter (D2) of the collar portion 216 being less than the diameter (D3) of the retention portion 208 allows for a portion of the connector 214 to extend beyond the first end 204 of the tube 202. The retention portion 208 prevents the connector 214 from being removed from the first end 204 by interfacing with the collar portion 216. Note that upon fracturing of the plurality of support members 212 the connector 214 may be moved to the end of the tube 202 and threads 226 may be machined into the interior sidewall of the connector 214 to enable the connector 214 to rotatably engage with the external member 500.

Returning to FIG. 2A, a plurality of additional additively manufactured support members 218 (e.g., 218A, 218B, 218C, 218D) are disposed on the tube 202. An additively manufactured engagement sleeve 220 is disposed on the plurality of additional support members 218 such that the plurality of additional support members 218 are connected between the tube 202 and the engagement sleeve 220. The plurality of additional support members 218 may act as spacers that allow for non-connected portions of the engagement sleeve 220 to be spaced apart from the tube 202. It will be appreciated that the engagement sleeve 220 may be supported by any suitable number of additional support members. For example, in other embodiments, the engagement sleeve 220 may be supported by more or less than four additional support members.

The plurality of additional support members 218 may be fracturable to allow movement of the engagement sleeve 220 with respect to the tube 202. FIGS. 4A and 4B are diagrammatic representations of a cross section of the additively manufactured assembly 200 along line B-B shown in FIG. 2A. In FIG. 4A, the plurality of additional support members 218 are intact. In FIG. 3B, the plurality of additional support members 218 are fractured to allow for the engagement sleeve 220 to move with respect to the tube 202. The engagement sleeve 220 forms a cylindrical interior cavity having an interior diameter (D5) that is greater than the exterior diameter (D1) of the tube 202. The interior diameter (D5) of the cylindrical interior cavity of the engagement sleeve 220 is also greater than the diameter (D3) of the retention portion 208. The engagement sleeve 220 includes a collar portion 222 having an interior diameter (D6) that is greater than the exterior diameter (D1) of the tube 202 and that is less than the diameter (D3) of the retention portion 208. An exterior diameter (D7) of the engagement sleeve 220 is less than an interior diameter (D4) of the connector 214.

Upon fracturing the plurality additional support members 218, the engagement sleeve 220 may slide laterally along the tube 202 such that the engagement sleeve 220 is positioned within the internal cavity of the connector 214, as shown in FIG. 2B. The arrangement of the interior diameter (D5) of the engagement sleeve being greater than the diameter (D3) of the retention portion 208, and the interior diameter (D6) of the collar portion 222 being less than the diameter (D3) of the retention portion 208 allows for a portion of the engagement sleeve 220 to extend beyond the first end 204 of the tube 202. Furthermore, the exterior diameter (D7) of the engagement sleeve 220 being less than the interior diameter (D4) of the connector 214 allows for the connector 214 to be positioned around the engagement sleeve 220.

Returning to FIG. 2A, a second connector 224 is disposed on the second end 206. The second connector 224 may be configured to engage with an additional external member (not shown) to hold the tube 202 in a position with respect to the additional external member. For example, the tube may be operable to connect two separate fittings together to allow for a transfer of fluid (e.g., air, water) between the two fittings. In the illustrated embodiment, the second connector 224 is formed integral to the tube such that the second connector 224 does not move with respect to the tube 202. In other embodiments, the second connector 224 may be formed on one or more support members in the same manner as the connector 214 such that the second connector 224 may be operable to move with respect to the tube 202 upon fracturing the support members. The second connector 224 may be configured to prevent the connector 214 and the engagement sleeve 220 from being removed from the second end 206. In this way, the connector 214 and the engagement sleeve 220 may be captively retained on the tube 202. In some embodiments, the second connector 224 optionally may be configured to be removable from the tube 202 to allow the connector 214 and the engagement sleeve 220 to be removed from the second end 206.

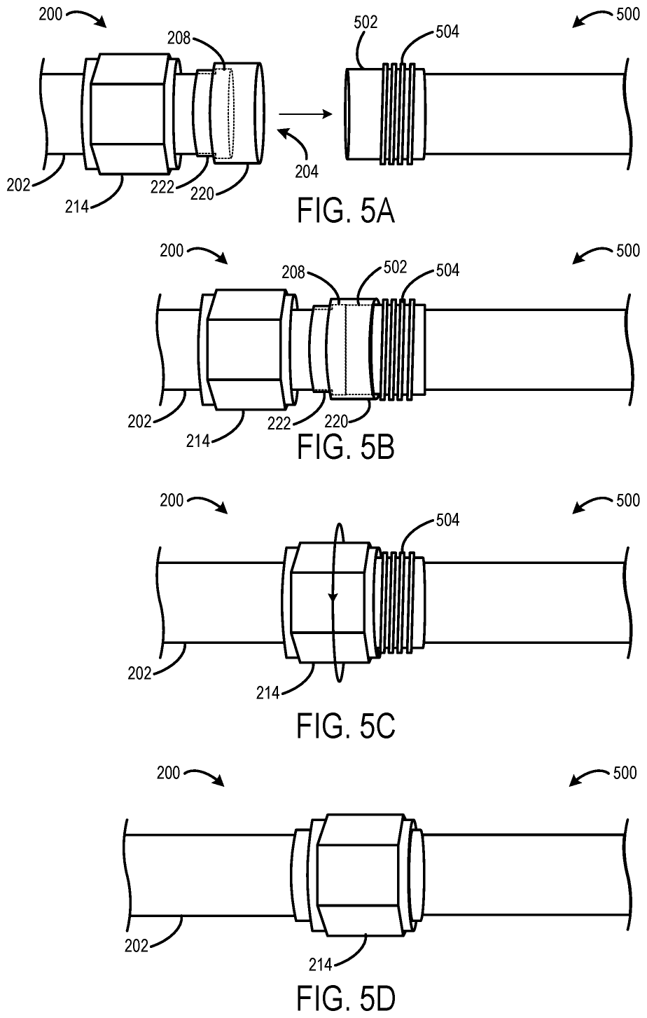

FIGS. 5A-5D are diagrammatic representations illustrating a process of the additively manufactured assembly 200 being connected to the external member 500. In this embodiment, the external member is a threaded fitting including an end portion 502 and a threaded portion 504, although it will be appreciated that the external member may take any suitable form. In FIG. 5A, the assembly 200 is aligned with the external member 500 such that the first end 204 of the tube 202 is aligned with the end portion 502 of the external member 500. Furthermore, the engagement sleeve 220 is slid to the first end 204 of the tube 202 such that the collar portion 222 of the engagement sleeve 220 buts up against the retention portion 208 of the tube 202 and a portion of the engagement sleeve 220 extends beyond the first end 204 of the tube.

In other embodiments, the engagement sleeve may be additively manufactured as part of the tube without fracturable support members such that the engagement sleeve is fixed relative to the tube. In such embodiments, the engagement sleeve may be incorporated into the retention portion and positioned at the first end of the tube. In such embodiments, the connector may be movable to slide over the engagement sleeve to engage the external member. In still other embodiments, the engagement sleeve may be omitted from the assembly, and the connector may engage with the external member directly.

In FIG. 5B, the assembly 200 interfaces with the external member 500 such that the end portion 502 of the external member 500 is flush against the first end 204 of the tube 202. The retention portion 208 and the end portion 502 of the external member 500 may have the same external diameter to aid in alignment between the tube 202 and the external member 500. Furthermore, the engagement sleeve 220 is slid over the end portion 502 of the external member 500 such that the end portion 502 is inserted within the internal cylindrical cavity of the engagement sleeve 220. The end portion 502 of the external member 500 may be sized such that the engagement sleeve 220 extends to the threaded portion 504 of the external member when the end portion 502 is inserted within the engagement sleeve 220.

In FIG. 5C, the connector 214 is rotated clockwise such that threads formed in the interior sidewall of the connector 214 engage the threaded portion 504 of the external member 500. In FIG. 5D, the connector 214 and the threaded portion 504 are engaged to connect the tube 202 with the external member 500 such that the tube 202 is held in position with respect to the external member 500. In particular, the connector 214 compresses the engagement sleeve 220 against the retention portion 208 of the tube 202 to form a compression-type fitting that creates a seal between the tube 202 and the external member 500.

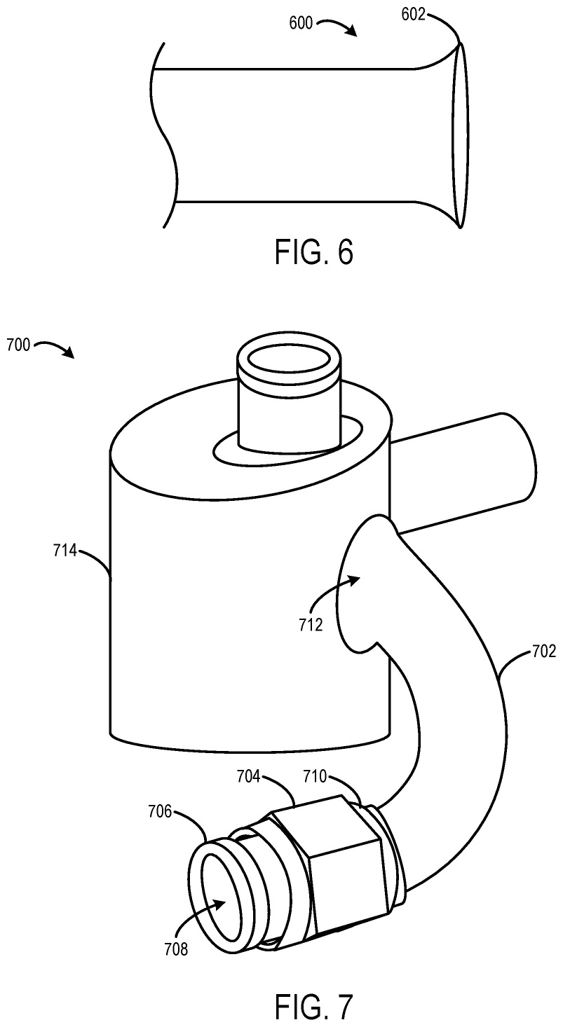

In the illustrated embodiment, the retention portion 208 of the tube 202 takes the form of a collar having sidewalls that are orthogonal to the exterior surface of the tube 202. In other embodiments, the retention portion may take other shapes. FIG. 6 is a diagrammatic representation illustrating an exemplary embodiment of a retention portion 600 of an additively manufactured parent member having a flared end 602. Note that the flared end 602 may be formed during additive manufacturing of the parent member as opposed to a secondary modification process of the parent member. The flared end 602 may have a diameter that is greater than the interior diameter of the collar portion 216 of the connector 214. The diameter of the flared end 602 may be less than the interior diameter of the connector 214. Also, the diameter of the flared end 602 may be greater than the collar portion 222 of the engagement sleeve 220 and less than the interior diameter of the engagement sleeve 220. It will be appreciated that the retention portion of the parent member of the additively manufactured assembly may take any suitable form that is configured to prevent a connector, a fastener, an engagement sleeve, and/or some other member from being removed from the first end of the parent member. The additively manufactured assembly 200 is provided as a non-limiting example. It will be appreciated that myriad variations may be contemplated.

In some embodiments, a connector may be captively retained on a parent member based on a geometry of the parent member. FIG. 7 is a diagrammatic representation of an exemplary embodiment of an additively manufactured assembly 700 including a parent member 702 and a connector 704 captively retained on the parent member 702. In this embodiment, the parent member 702 takes the form of a tube connected to air separator device that is configured to separate air and water in an intake of a vehicle. It will be appreciated that the connector 704 may be additively manufactured on support member(s) (not shown) disposed on the tube 702 in the same manner as described with respect to the additively manufactured assembly 200 shown in FIG. 2A. The support member(s) may be fracturable to allow movement of the connector 704 with respect to the tube 702. A retention portion 706 is disposed on a first end 708 of the tube 702. The retention portion 706 has a diameter that is greater than an interior diameter of a collar portion 710 of the connector 704 such that the retention portion 706 is configured to prevent the connector 704 from being removed from the first end 708 of the tube 702. A second end 712 of the tube 702 is connected to a body 714 of the air separator device. The body 714 of the air separator device is larger than a diameter of the interior diameter of the collar portion 710 of the connector 704 such that the body 714 of the air separator device is configured to prevent the connector 704 from being removed from the second end 712 of the tube 702. Accordingly, the connector 704 may be captively retained on the tube 702. It will be appreciated that an additively manufactured parent member may take any suitable form to captively retain an additively manufactured connector on the parent member.

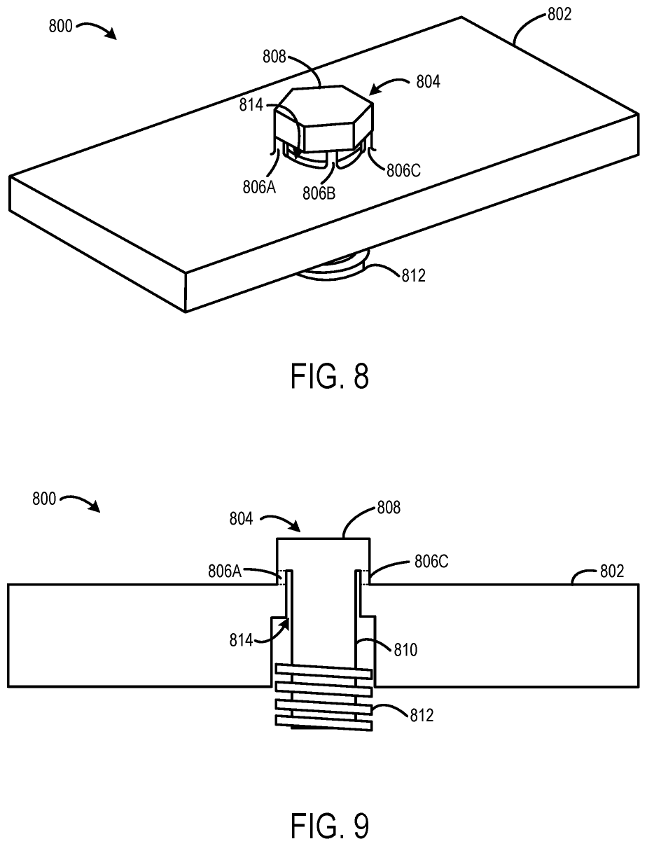

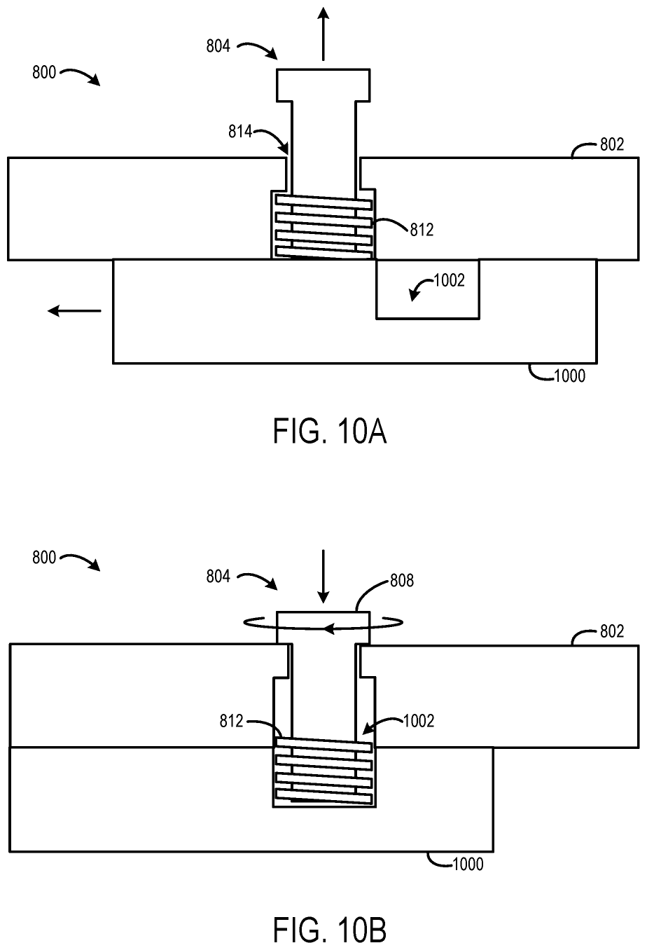

FIGS. 8 and 9 are diagrammatic representations of an exemplary embodiment of an additively manufactured assembly 800 including an additively manufactured parent member 802 and an additively manufactured fastener 804. For example, the additively manufactured assembly 800 may be additively manufactured according to the additive manufacturing method 100 shown in FIG. 1. The additively manufactured parent member 802 may take any suitable form having any suitable geometry. In the illustrated embodiment, the parent member takes the form of a plank or sheet. In other embodiments, the parent member may take the form of a tube similar to the tube 202 shown in FIGS. 2A and 2B. A plurality of additively manufactured support members 806 (e.g., 806A, 806B, 806C) are disposed on the parent member 802. The additively manufactured fastener 804 is disposed on the plurality of support members 806 such that the plurality of support members 806 are connected between the parent member 802 and the fastener 804. The fastener 804 includes a head portion 808, a neck portion 810, and a threaded portion 812. The head portion 808 is hexagonal shaped to accommodate a wrench or other tool for gripping and rotating the fastener 804 to tighten the fastener 804 into an external member 1000 (shown in FIGS. 10A and 10B). The neck portion 810 spans the head portion 808 and the threaded portion 810 of the fastener 804. The neck portion 810 extends through an aperture 814 that is formed in the parent member 802. The aperture 814 has a diameter that is greater than a diameter of the neck portion 810 such that when the support members 806 are fractured, the fastener 804 is orthogonally movable with respect to the parent member 802. Further, the diameter of the aperture 814 is less than a diameter of the head portion 808 and a diameter of the threaded portion 812. As such, the aperture 814 acts a retention portion of the parent member 802 and is configured to prevent the fastener 804 from being removed from the parent member 802.

The additively manufactured assembly 800 is provided as anon-limiting example. It will be appreciated that myriad variations may be contemplated. For example, the support member(s) may be connected between the fastener and the parent member at other locations depending on the relative positions of the fastener and the parent member.

FIGS. 10A-10B are diagrammatic representations illustrating a process of the additively manufactured assembly 800 being connected to an external member 1000. In FIG. 10A, the plurality of support members 806 have been fractured/removed from the assembly 800 to allow the fastener 804 to move orthogonally with respect to the parent member 802. The fastener 804 is translated upward through the aperture 814 such that the threaded portion 812 of the fastener 804 buts up against an underside of the parent member 802. The fastener 804 may be moved into this position to allow for the external member 1000 to be aligned with the assembly 800. In particular, the external member 1000 includes a cavity 1002 that is configured to receive the fastener 804. The external member 1000 may be aligned with the assembly 800 when the cavity 1002 is aligned with the threaded portion 812 of the fastener 804.

In FIG. 10B, the head portion 808 of the fastener 804 is rotated clockwise to rotatably engage the threaded portion 812 of the fastener 804 into the cavity 1002 of the external member 1000. The fastener 804 may be operable to threadedly engage the external member 1000 to hold the parent member 802 in a position with respect to the external member 1000. As one example, the external member maybe a fitting that is inserted into a tube and the fastener may hold the tube in a position relative to the fitting.

The systems and processes described herein have the potential benefit of significantly reducing manufacturing cycle times for additively manufactured assemblies by eliminating steps required to modify various members of the assemblies subsequent to the initial additive manufacturing formation process. For example, by using the disclosed additive manufacturing methods and processes a parent member of an assembly need not be modified to form a retention portion for a connector or a fastener, because the connector or fastener may be formed on the parent member during the additive manufacturing process instead of being formed separately and added during a subsequent manufacturing step. Moreover, systems, assemblies, and apparatuses described herein may be made more robust by not having to be modified after the additive manufacturing formation process to form such retention portions.

The present disclosure includes all novel and non-obvious combinations and subcombinations of the various features and techniques disclosed herein. The various features and techniques disclosed herein are not necessarily required of all examples of the present disclosure. Furthermore, the various features and techniques disclosed herein may define patentable subject matter apart from the disclosed examples and may find utility in other implementations not expressly disclosed herein.

1. A method comprising:
additively manufacturing a parent member including a first end and a retention portion proximate to the first end;
additively manufacturing at least one support member onto the parent member; and
additively manufacturing a connector onto the at least one support member such that the at least one support member is connected between the parent member and the connector,
wherein the at least one support member is fracturable to allow movement of the connector with respect to the parent member,
wherein the retention portion is configured to prevent the connector from being removed from the first end upon fracturing of the at least one support member, and
wherein the connector is operable to engage an external member to hold the parent member in a position with respect to the external member.

2. The method of claim 1, further comprising:
removing the at least one support member to allow movement of the connector with respect to the parent member.

3. The method of claim 1, further comprising:
additively manufacturing at least one additional support member onto the parent member;
additively manufacturing an additional member onto the at least one additional support member;
wherein the at least one additional support member is fracturable to allow movement of the additional member with respect to the parent member, and
wherein the retention portion is configured to prevent the additional member from being removed from the first end upon fracturing of the at least one additional support member.

4. The method of claim 3, wherein additively manufacturing the parent member includes additively manufacturing a tube, wherein the additional member includes an engagement sleeve, and wherein the engagement sleeve is operable to interface with the retention portion, the connector, and the external member to form a seal between the tube and the external member.

5. The method of claim 3, further comprising:
removing the at least one additional support member to allow movement of the additional member with respect to the parent member.

6. The method of claim 1, wherein the external member includes a threaded portion, and wherein the method further comprises forming matching threads on the connector such that the connector is operable to rotatably engage the threaded portion with the matching threads.

7. The method of claim 1, wherein additively manufacturing the parent member, the at least one support member, and the connector includes direct metal laser sintering the parent member, the at least one support member, and the connector.

8. The method of claim 1, wherein the parent member, the at least one support member, and the connector are additively manufactured from at least one of metal or plastic.

9. An additively manufactured assembly comprising:
an additively manufactured tube including a first end and a retention portion proximate to the first end;
at least one additively manufactured support member disposed on the additively manufactured tube; and
an additively manufactured connector disposed on the at least one additively manufactured support member such that the additively manufactured support member is connected between the additively manufactured tube and the additively manufactured connector, the additively manufactured support member being fracturable to allow movement of the additively manufactured connector with respect to the additively manufactured tube,
wherein the retention portion is configured to prevent the additively manufactured connector from being removed from the first end upon fracturing of the at least one additively manufactured support member, and
wherein the additively manufactured connector is operable to engage an external member to hold the additively manufactured tube in a position with respect to the external member.

10. The additively manufactured assembly of claim 9, further comprising:
at least one additional additively manufactured support member disposed on the additively manufactured tube; and
an additively manufactured engagement sleeve disposed on the at least one additional additively manufactured support member,
wherein the at least one additional additively manufactured support member is fracturable to allow movement of the additively manufactured engagement sleeve with respect to the additively manufactured tube,
wherein the retention portion is configured to prevent the additively manufactured engagement sleeve from being removed from the first end upon fracturing of the at least one additional additively manufactured support member, and
wherein the additively manufactured engagement sleeve is operable to interface with the connector, the retention portion, and the external member to form a seal between the additively manufactured tube and the external member.

11. The additively manufactured assembly of claim 9, wherein the external member includes a threaded portion, and wherein the additively manufactured connector includes matching threads such that the additively manufactured connector is operable to rotatably engage the threaded portion with the matching threads.

12. The additively manufactured assembly of claim 9, wherein the retention portion surrounds a perimeter of the tube, wherein the retention portion has a diameter that is greater than an exterior diameter of the tube, and wherein at least a portion of the connector has an interior diameter that is less than the diameter of the retention portion.

13. The additively manufactured assembly of claim 12, wherein the retention portion includes a flared end.

14. The additively manufactured assembly of claim 12, wherein the retention portion includes sidewalls orthogonal to a wall of the tube.

15. The additively manufactured assembly of claim 12, wherein the retention portion forms at least part of a compression-type fitting.

16. The additively manufactured assembly of claim 9, wherein the connector is captively retained on the tube.

17. The additively manufactured assembly of claim 9, wherein the additively manufactured tube, the at least one additively manufactured support member, and the additively manufactured connector are additively manufactured from at least one of metal or plastic.

18. A method comprising:
additively manufacturing a parent member including a first end and a retention portion proximate to the first end;
additively manufacturing at least one support member onto the parent member; and
additively manufacturing a connector or a fastener onto the at least one support member such that the at least one support member is connected between the parent member and the connector or the fastener,
wherein the at least one support member is fracturable to allow movement of the connector or the fastener with respect to the parent member,
wherein the retention portion is configured to prevent the connector or the fastener from being removed from the first end upon fracturing of the at least one support member, and
wherein the connector or the fastener is operable to engage an external member to hold the parent member in a position with respect to the external member.

19. The method of claim 18, wherein additively manufacturing a connector or a fastener onto the at least one support member includes additively manufacturing a fastener onto the at least one support member, and wherein the fastener is operable to be inserted into a receiving portion of the external member to hold the parent member in a position with respect to the external member.

20. The method of claim 19, wherein the fastener is a threaded fastener operable to threadedly engage the parent member and the external member to hold the parent member in the position with respect to the external member.
